(19) United States
(12) Patent Application Publication
(10) Pub. No.: US 2009/0119763 A1
(43) Pub. Date: May 7, 2009

(54) METHOD AND SYSTEM FOR PROVIDING SINGLE SIGN-ON SERVICE

(76) Inventors: So-Hee PARK, DaeJeon (KR); Byeong-Cheol CHOI, DaeJeon (KR); Jae-Deok LIM, DaeJeon (KR); Jeong-Nyeo KIM, DaeJeon (KR)

Correspondence Address: LADAS & PARRY LLP, 224 SOUTH MICHIGAN AVENUE, SUITE 1600, CHICAGO, IL, 60604, US

(21) Appl. No.: 12/182,536

(22) Filed: Jul. 30, 2008

(30) Foreign Application Priority Data
Nov. 6, 2007 (KR) 10-2007-0112538

(51) Int. Cl. H04L 9/32

(52) U.S. Cl. 726/8

(57) ABSTRACT

Provided is a method and system for providing an SSO service enabling the use of Web services in different trusted domains through a one-time authentication process. In the method, mutual authentication information is issued from a trusted third party to each of ID-federation service providers managing each of trusted domains, and an ID federation established between the ID-federation service provider and a user in the trusted domain of the ID-federation service provider. The first ID-federation service provider managing the first trusted domain, to which the user belongs to, is confirmed when a Web service provider in the second trusted domain receives a login request from the user in the first trusted domain. User authentication and mutual authentication arc performed between the first ID-federation service provider and a second ID-federation service provider managing the second trusted domain. The Web service provider authenticates the user in the first trusted domain and provides a corresponding Web service.

### CROSS-REFERENCE TO RELATED APPLICATIONS

This application claims priority under 35 U.S.C. §119 to Korean Patent Application No. 10-2007-112538, filed on Nov. 6, 2007, the disclosure of which is incorporated herein by reference in its entirety.

### BACKGROUND OF THE INVENTION

1. Field of the Invention

The present disclosure relates to a Single Sign-On (SSO) service system, and more particularly, to a method and system for providing an SSO service, which makes it possible use Web services of different trusted domains as well as a single trusted domain (STD) through a single ID registered for user authentication.

This work was supported by the IT R&D program of MIC/IITA.

[2007-S-016-01, A Development of Cost Effective and Large Scale Global Internet Service Solution]

2. Description of the Related Art

Single Sign-On (SSO) is security application solution that enables connection to a variety of Internet services or systems of enterprises through a one-time login. The SSO makes it possible to access a variety of systems through only one user ID without separate authentication processes for the respective systems, thereby preventing the security risk for IDs and passwords, increasing the convenience of users, and reducing the authentication management costs.

In the case of a related art SSO service system, a plurality of Web service providers (i.e., Web sites) construct one trusted domain, and an ID-federation service provider managing user IDs in the trusted domain associates users IDs with IDs of the Web service providers, thereby making it possible to use a plurality of Web services in a single domain through a one-time authentication process. In the case of a multiple trusted domain (MTD) SSO service, a centralized relay server is additionally provided to associate ID-federation service providers of multiple trusted domains, which is suitable only for places supporting a centralized scheme such as an SSO service of a public organization.

However, in the case of the related art SSO service system, to associate a variety of Web service providers into a single trusted domain (STD) and to federate a plurality of trusted domains into a multiple trusted domain using a centralized ID-federation relay server are not practically viable. Therefore, the related art STD SSO service and MTD SSO service are not suitable for the environments of Web portal services.

### SUMMARY

Therefore, an object of the present invention is to provide a method and system for providing an SSO service, which makes it possible use Web services of different trusted domains as well as a single trusted domain through authentication by a single ID/password registered for user authentication.

Another object of the present invention is to provide a method and system for providing an SSO service, which performs mutual authentication for ID-federation service providers of different trusted domains through mutual authentication information issued by a trusted third party, and makes it possible to use Web services of different domains through federated authentication information generated according to the login of a user registered in a Web site of a specific domain.

Another object of the present invention is to provide a method and system for providing an SSO service, which makes it possible to enjoy a Web service using an anonymous ID instead of a real-name ID when user privacy protection is required.

Another object of the present invention is to provide a method and system for providing an SSO service, which makes it possible to release a connection to a plurality of Web sites through a one-time logout process when using Web services of different domains through federated authentication information.

Another object of the present invention is to provide a method and system for providing an SSO service, which makes it possible to select SSO-based Web sites among Web sites in a single domain at the request of a user.

To achieve these and other advantages and in accordance with the purpose(s) of the present invention as embodied and broadly described herein, a method for providing an SSO service enabling the use of Web services in different trusted domains through a one-time authentication process in accordance with an aspect of the present invention includes: issuing mutual authentication information from a trusted third party to each of ID-federation service providers managing each of trusted domains, and establishing an ID federation between the ID-federation service provider and a user in the trusted domain of the ID-federation service provider; confirming the first ID-federation service managing the first trusted domain to which the user belongs to, when a Web service provider in the second trusted domain receives a login request from the user in the first trusted domain; performing user authentication and mutual authentication between the first ID-federation service provider and a second ID-federation service provider managing the second trusted domain; and the Web service provider authenticating the user in the first trusted domain and providing a corresponding Web service.

To achieve these and other advantages and in accordance with the purpose(s) of the present invention, a method for providing an SSO service enabling the use of Web services in different trusted domains through a one-time authentication process in accordance with another aspect of the present invention includes: a user registering a real-name user ID in an ID-federation service provider; the ID-federation service provider issuing an anonymous user ID corresponding to the real-name user ID; setting one or more Web service providers in the trusted domain as a federated Web service provider at the request of the user; and the user connecting to the federated Web service provider through the anonymous user ID at the request for connection to the federated Web service provider.

To achieve these and other advantages and in accordance with the purpose(s) of the present invention, a system for providing an SSO service enabling the use of Web services in first and second trusted domains through a one-time authentication process in accordance with another aspect of the present invention includes: a first ID-federation service provider for managing a plurality of first Web service providers in the first trusted domain; a second ID-federation service provider for managing a plurality of second Web service providers in the second trusted domain; and a trusted third party for issuing authentication information for authentication of the first and second ID-federation service providers, wherein when a service provision request is transmitted from a user terminal in the first trusted domain to the second Web service provider in the second trusted domain, the first and second ID-federation service providers perform mutual authentication by using the authentication information and perform a user authentication process by sharing federated authentication information generated by the first ID-federation service provider.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of an MTD SSO service system according to an embodiment of the present invention;

FIG. 2 is a flow diagram illustrating an authentication method of the MTD SSO service system according to an embodiment of the present invention;

FIG. 3 is a flow diagram illustrating an MTD single logout process according to an embodiment of the present invention;

FIG. 4 is a flow diagram illustrating a process for establishing an ID federation in a single trusted domain according to an embodiment of the present invention; and

FIG. 5 is a flow diagram illustrating a process for releasing ID federation establishment in a single trusted domain according to an embodiment of the present invention.

### DETAILED DESCRIPTION OF EMBODIMENTS

Hereinafter, specific embodiments will be described in detail with reference to the accompanying drawings.

The detailed description set forth below in connection with the appended drawings is intended as a description of various embodiments of the present invention and is not intended to represent the only embodiments described herein. The detailed description includes specific details for the purpose of providing a comprehensive understanding of the present invention. However, it will be apparent to those skilled in the art that the present invention may be practiced without these specific details.

A user authentication system and method of the present invention is to expand an SSO service in order to prevent the inconvenience for a plurality of Web service provides to have to register and manage different IDs. Using authentication information issued from a trusted third party, an ID-federation service provider managing a trusted domain performs mutual authentication with an ID-trusted service provider managing another trusted domain, thereby making it possible to use authentication information of a single trusted domain (STD) in a multiple trusted domain (MTD). An ID federation is established so that a variety of Web services can be received from Web service providers of different trusted domains by using only one registered ID. In this process, an ID-federation service provider issues an anonymous ID for use of Web services to a user, thereby preventing leakage of personal information due to a real-name user ID.

Throughout the present specification, the term “trusted domain” is used to denote a virtual region that includes a plurality of Web service providers for an SSO service and provides mutual trust for authentication results. Also, the term “multiple domain federation service” is used to denote a service that make it possible to connect to Web sites of different trusted domains by using a user ID pre-registered in a single trusted domain. Also, the term “federated authentication information” is used to denote information that make it possible to connect to Web sites of different trusted domains by using authentication information pre-registered in a single trusted domain.

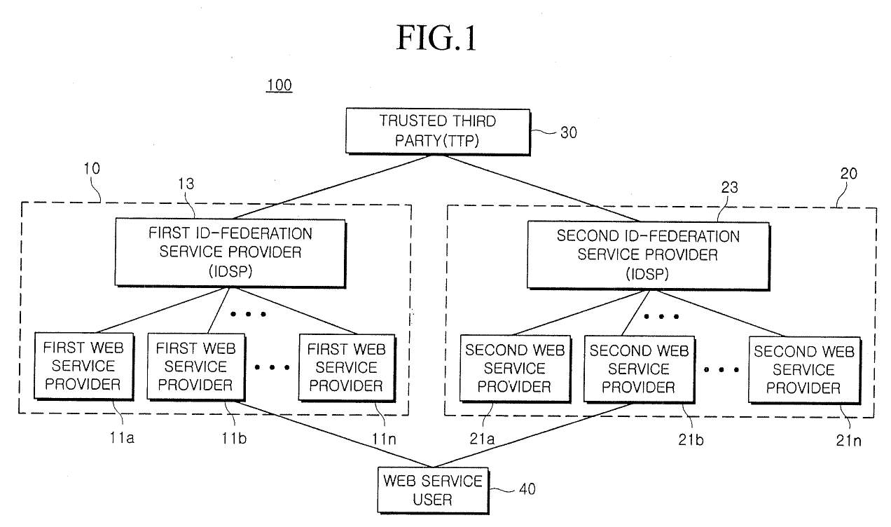

FIG. 1 is a block diagram of an MTD SSO service system according to an embodiment of the present invention. Although three trusted domains (i.e., first and second trusted domains 10 and 20) are illustrate din FIG. 1, it will be apparent that the present invention can also be applied to the use of three or more trusted domains.

Referring to FIG. 1, an MTD SSO service system 100 includes: a plurality of first Web service providers 11a-11n for providing different Web sites; a plurality of second Web service providers 21a-21n for providing different Web sites; a first ID-federation service provider (IDSP) 13 for controlling the first Web service providers 11a-11n; a second ID-federation service provider 23 for controlling the second Web service providers 21a-21n; and a trusted third party 30 for issuing mutual authentication information to the first and second ID-federation service providers 13 and 23. Herein, the first Web service providers 11a-11n and the first ID-federation service provider 13 constitute a first trusted domain 10, while the second Web service providers 21a-21n and the second ID-federation service provider 23 constitute a second trusted domain 20.

The first and second Web service providers 11a-11n and 21a-21n provide a variety of Wed services in the form of Web sites. A plurality of the first/second Web service providers 11a-11n/21a-21n may be included in the first/second trusted domain 10/20. The first and second ID-federation service providers 13 and 23 establish a federation of user IDs for the first and second Web service providers 11a-11n and 21a-21n and links federation ID information to user ID information. In an SSO login mode, the first/second Web service providers 11a-11n/21a-21n transmit a user authentication request to the first/second ID-federation service provider 13/23 in the first/second trusted domain 10/20, and confirm the user authentication to perform a login process according to a response to the user authentication request.

The first/second ID-federation service provider 13/23 controls the first/second Web service providers 11a-11n/21a-21n in the first/second trusted domain 10/20, manages anonymous IDs and real-name user IDs, and establishes/releases an ID federation of the first/second Web service providers 11a-11n/21a-21n in the first/second trusted domain 10/20. In an MTD federation service request mode, the first/second ID-federation service provider 13/23 generates federated authentication information through mutual authentication with other ID-federation service provider (e.g., the second/first ID-federation service provider 23/13) by using authentication information issued by the trusted third party 30, so that a plurality of trusted domains can be used through the generated federated authentication information.

For example, a user ID registered in the first ID-federation service provider 13 can connect to the second Web service providers 21a-21n, which is controlled by the second ID-federation service provider 23, through authentication with the second ID-federation service provider 23 by federated authentication information generated by the first ID-federation service provider 13.

The trusted third party 30 issues authentication information for mutual authentication to the first and second ID-federation service providers 13 and 23 to enable an ID federation between multiple trusted domains. This enables the first and second ID-federation service providers 13 and 23 to trust each other. Examples of the trusted third party 30 include a certificate authority (CA) and any other types of trusted thirty parties. Also, examples of the authentication information for mutual authentication between servers include a server certificate and any other types of authentication information. When a server certificate issued by a certificate authority is used, users or other servers can authenticate the fact that the first and second ID-federation service providers 13 and 23 are not illegal sites such as “phishing” sites.

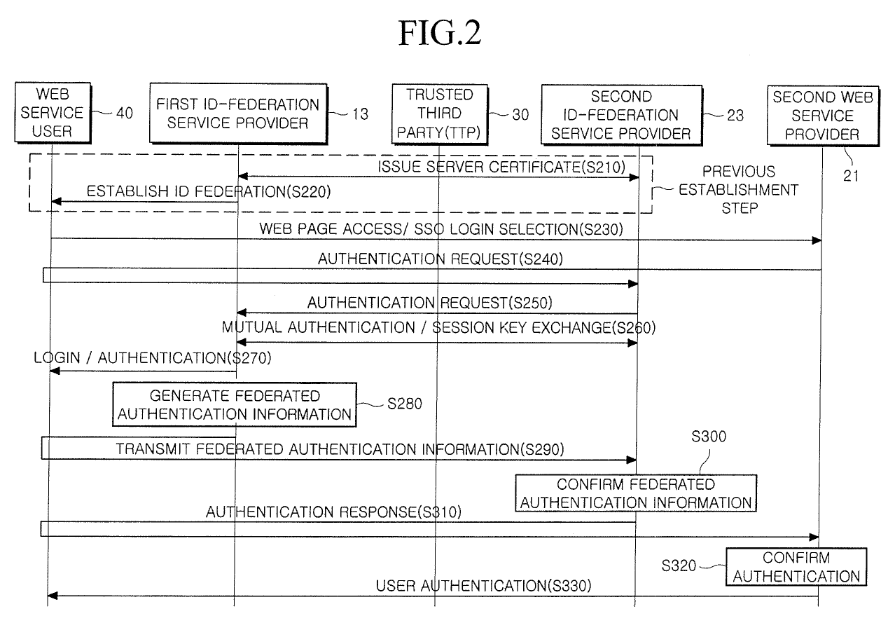

FIG. 2 is a flow diagram illustrating an authentication method of the MTD SSO service system according to an embodiment of the present invention.

Referring to FIG. 2, it is assumed that the trusted third party 30 has issued authentication information for mutual authentication to the first and second ID-federation service providers 13 and 23 (in step S210), and that an ID federation has been established between a Web service user 40 and the first ID-federation service provider 13 (in step S220). The present embodiment will be described on the assumption that the Web service user 40 in the first trusted domain 10 is to connect to the second Web service provider 21 in the second trusted domain 20.

Thereafter, the Web service user 40 connects to the second Web service providers 21a-21n in the second trusted domain 20 (not the first trusted domain 10 where the Web service user 40 has registered), and selects an SSO login window (not an ID/PW login window) to receive a Web service. Then, the Web service user 40 selects the first ID-federation service provider 13 (where the Web service user 40 has registered) from an ID-federation service provider list in the SSO login window to notify information about the first ID-federation service provider 13. On the other hand, if the first ID-federation service provider 13 is not present in the ID-federation service provider list, the Web service user 40 personally inputs the Web site name of the first ID-federation service provider 13 in a text window (in step S230).

Thereafter, the second Web service provider 21 transmits a user authentication request to the second ID-federation service provider 23 that manages the domain of the second Web service provider 21 (in step S240).

Thereafter, the second ID-federation service provider 23 detects the fact that the Web service user 40 has registered in the first ID-federation service provider 13, and transmits a user authentication request to the first ID-federation service provider 13, and the first and second ID-federation service providers 13 and 23 perform mutual authentication using mutual authentication information that has been issued and received from the trusted third party 30 (in steps S250). Examples of a scheme for the mutual authentication include a challenge-response scheme, a Diffie-Hellman scheme, and any other types of mutual authentication schemes. The challenge-response scheme and the Diffie-Hellman scheme are known in the art and thus their detailed description is not provided herein. Thereafter, the first and second ID-federation service providers 13 and 23 perform mutual authentication and generates a session key (in step S260). The session key may be generated by a Diffie-Hellman key exchange scheme, to which the present invention is not limited.

Thereafter, the first ID-federation service provider 13 displays its login window to the Web service user 40. Then, the Web service user 40 detects the fact that the displayed login window is a login window provided by the first ID-federation service provider 13, and performs a login using a pre-registered ID and password (in step S270).

Thereafter, the first ID-federation service provider 13 generates federated authentication information (in step S280), encrypts the federated authentication information with the session key, and transmits the encrypted federated authentication information to the second ID-federation service provider 23 (in step S290). Herein, the federated authentication information may be generated using the Security Assertion Markup Language (SAML) 2.0, to which the present invention is not limited. The SAML is known in the art and thus its detailed description is not provided herein.

The second ID-federation service provider 23 receives the federated authentication information, decrypts the federated authentication information with the session key, and register/updates user authentication information in a multiple-domain ID management list among its own ID information management lists (in step S300). Thereafter, the second ID-federation service provider 23 transmits the federated authentication information to the second Web service provider 21 (in step S310).

Upon receiving the federated authentication information together with an authentication response, the second Web service provider 21 confirms the authentication and completes the user authentication (in step S320). Thereafter, the second Web service provider 21 provides the resulting data of the user authentication confirmation to the Web service user 40 (in step S330).

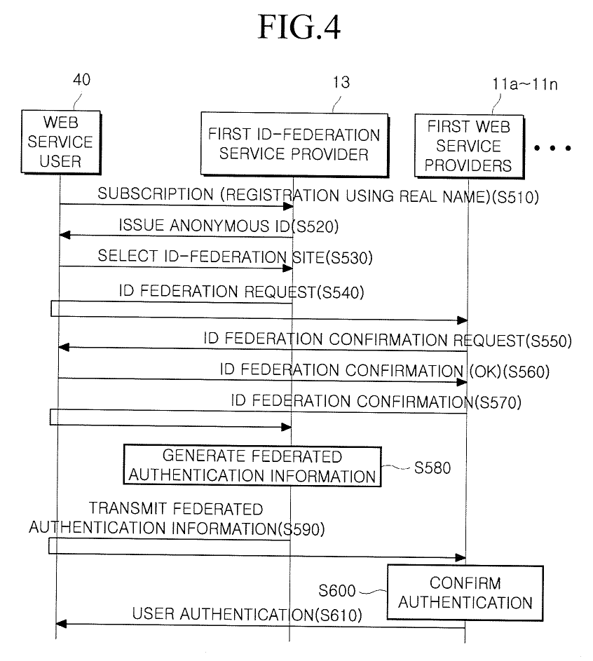

A process for ID federation between the first ID-federation service provider 13 and the Web service user 40 (in step S220) will be described later in detail with reference to FIG. 4.

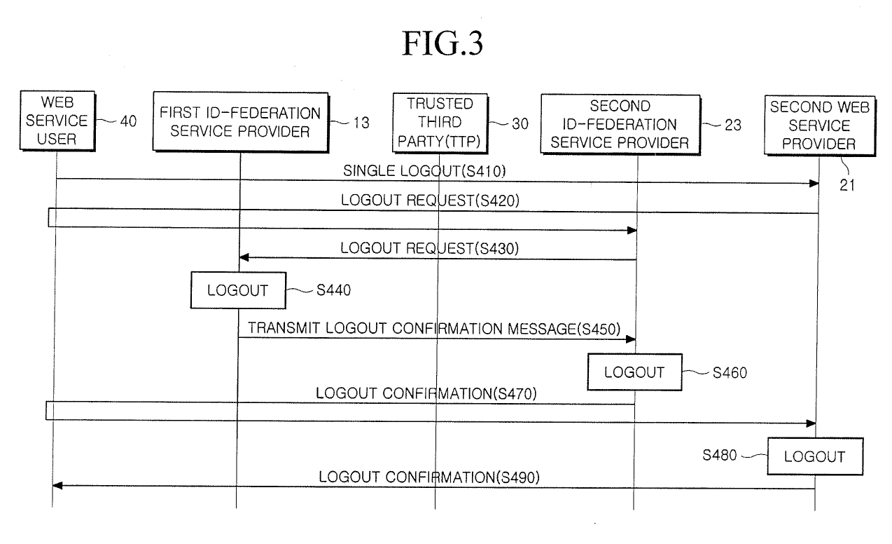

FIG. 3 is a flow diagram illustrating a single logout process for multiple trusted domains according to an embodiment of the present invention. A single logout service enables users to log out a plurality of connected MTD Web sites through a one-time logout process.

Referring to FIG. 3, it is assumed that that the Web service user 40 in the first trusted domain 10 is to perform a single logout from a Web site of the second Web service provider 21.

When the Web service user 40 attempts a single logout (in step S410), the second Web service provider 21 transmits a logout request to the second ID-federation service provider 23 (in step S420).

Thereafter, the second ID-federation service provider 23 detects through a user ID management list the fact that the Web service user 40 has registered in the first trusted domain 10, and transmits a logout request to the first ID-federation service provider 13 (in step 430).

Thereafter, the first ID-federation service provider 13 completes a user logout (in step S440), and transmits a logout confirmation message to the second ID-federation service provider 23 (in step S450).

Thereafter, the second ID-federation service provider 23 completes a user logout according to the logout confirmation message received from the first ID-federation service provider 13 (in step S460), and transmits a logout confirmation message to the second Web service provider 21 (in step S470).

Thereafter, the second Web service provider 21 completes a user logout according to the logout confirmation message received from the second ID-federation service provider 23 (in step S480), and transmits a logout confirmation message to inform the Web service user 40 that the logout has been completed (in step S490).

Hereinafter, a process for establishing an ID federation in the first trusted domain 10 for connection to a specific Web site through a one-time login (in step S220) will be described in detail with reference to FIG. 4.

FIG. 4 is a flow diagram illustrating a process for establishing an ID federation in a single trusted domain according to an embodiment of the present invention.

Referring to FIG. 4, the first ID-federation service provider 13 receives the real name of the Web service user 40 to register a real-name ID (in step S510). Thereafter, the first ID-federation service provider 13 confirms the registered real-name ID, and issues an anonymous ID to be used for a user privacy protection service (in step S520).

Thereafter, the Web service user 40 requests the first ID-federation service provider 13 to select some of the first Web service providers 11a-11n to be federated in the first trusted domain 10 (in step S530). Thereafter, the first ID-federation service provider 13 transmits an ID federation request to the selected 11a-11n (in step S540). Herein, if the Web service user 40 does not select the first Web service providers 11a-11n, an ID federation is performed on all the first Web service providers 11a-11n in the first trusted domain 10.

Thereafter, the first Web service providers 11a-11n transmit an ID federation confirmation request to the Web service user 40 (in step S550), and receives an ID federation confirmation message from the Web service user 40 (in step S560).

Thereafter, the first Web service providers 11a-11n transmits an ID federation confirmation message to the first ID-federation service provider 13 (in step 570). Then, the first ID-federation service provider 13 generates federated authentication information (in step S5800, and transmits the federated authentication information to the first Web service providers 11a-11n (in step S590).

Thereafter, using the federated authentication information received from the first ID-federation service provider 13, the first Web service providers 11a-11n confirm the authentication to complete the user authentication (in step S600). Thereafter, the first Web service providers 11a-11n inform the Web service user 40 that the user authentication has been completed (in step 610). Herein, the first ID-federation service provider 13 and the first Web service providers 11a-11n manage a user ID list. The first ID-federation service provider 13 manages real-name user IDs, anonymous user IDs, and a federated site list, and the first Web service providers 11a-11n manage anonymous user IDs and a federated site list.

The above process for the ID federation between the first ID-federation service provider 13 and the first Web service providers 11a-11n must be repeated as many times as the number of the first Web service providers 11 to which the first ID-federation service provider 13 has transmitted the ID federation request.

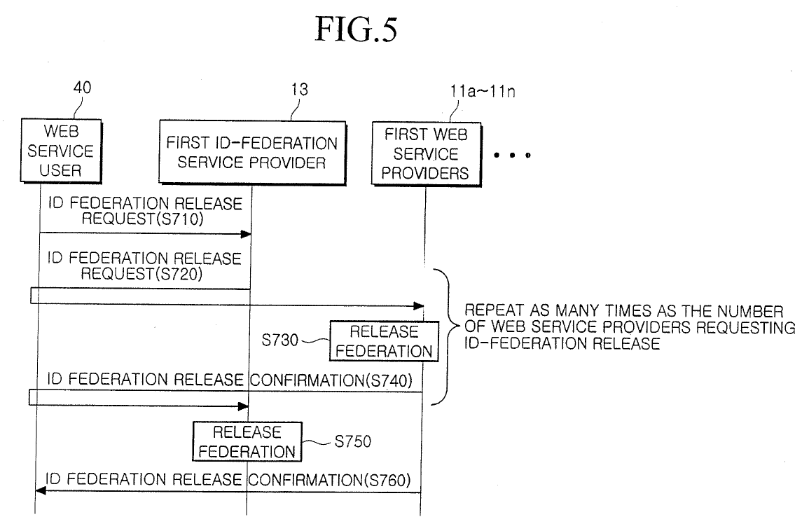

FIG. 5 is a flow diagram illustrating a process for releasing ID federation establishment in a single trusted domain according to an embodiment of the present invention.

Referring to FIG. 5, the Web service user 40 requests the first ID-federation service provider 13 to release an ID federation of an ID-federated one of the first Web service providers 11a-11n (in step S710). Then, the first ID-federation service provider 13 transmits an ID federation release request message to the corresponding first Web service provider 11 (in step S720).

Then, the corresponding first Web service provider 11 releases an ID federation with the first ID-federation service provider 13 (in step S730), and transmits an ID federation release confirmation message to the first ID-federation service provider 13 (in step S740).

Then, the first ID-federation service provider 13 releases the ID federation (in step S750), and transmits an ID federation release confirmation message to the Web service user 40 (in step S760).

Upon completion of release of the ID federation, the first ID-federation service provider 13 and the corresponding first Web service provider 13 delete ID federation information of the Web service user 40 from the corresponding ID management list.

The process for the first ID-federation service provider 13 to release an ID federation with the first Web service providers 11a-11n must be repeated as many times as the number of the Web service providers to which the first ID-federation service provider 13 has transmitted an ID federation release request.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, the present invention performs mutual authentication between ID-federation service providers managing a Web site of a single domain through authentication information issued by a trusted third party, and generates federated authentication information enabling a Web site login between different trusted domains through a pre-registered ID, thereby preventing the inconvenience of having to register an ID for every Web site by inputting personal information.

Also, the present invention makes it possible to use an anonymous ID instead of a real-name ID in an SSO Web service, thereby preventing leakage of personal information.

Also, the present invention makes it possible to release a connection to a plurality of Web sites through a one-time logout process when using Web services of different domains.

Also, the present invention makes it possible to select SSO-based Web sites among Web sites in a single domain according to the user's taste, thereby increasing the user's convenience.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A method for providing a Single Sign-On (SSO) service enabling the use of Web services in different trusted domains through a one-time authentication process, the method comprising:
issuing mutual authentication information from a trusted third party to each of ID-federation service providers managing each of trusted domains, and establishing an ID federation between the ID-federation service provider and a user in the trusted domain of the ID-federation service provider;
confirming the first ID-federation service provider managing the first trusted domain to which the user belongs to, when a Web service provider in the second trusted domain receives a login request from the user in the first trusted domain;
performing user authentication and mutual authentication between the first ID-federation service provider and a second ID-federation service provider managing the second trusted domain; and
the Web service provider authenticating the user in the first trusted domain and providing a corresponding Web service.

2. The method of claim 1, wherein the confirming of the first ID-federation service provider comprises:
transmitting an authentication request from the Web service provider to the second ID-federation service provider; and
receiving information of the first ID-federation service provider at the authentication request.

3. The method of claim 1, wherein the performing of the user authentication comprises:
transmitting an authentication request from the second ID-federation service provider to the first ID-federation service provider;
performing mutual authentication between the first and second ID-federation service providers using the mutual authentication information issued from the trusted third party;
the first ID-federation service provider providing a login window to the user and generating federated authentication information by receiving an ID and password; and
the second ID-federation service provider receiving the federated authentication information, confirming the federated authentication information, and updating a multiple domain ID management list thereof.

4. The method of claim 3, wherein the providing of the corresponding Web service comprises:
transmitting the federated authentication information from the second ID-federation service provider to the second Web service provider; and
the Web service provider receiving the federated authentication information, confirming that the user is an authenticated user, and providing the corresponding Web service to the user.

5. The method of claim 3, wherein the mutual authentication is performed using authentication schemes including a challenge-response scheme and a Diffie-Hellman scheme.

6. The method of claim 3, wherein the federated authentication information is encrypted with a predetermined session key by the first ID-federation service provider, and the encrypted federated authentication information is decrypted with the session key by the second ID-federation service provider.

7. The method of claim 6, wherein the session key is shared by the first and second ID-federation service providers through the mutual authentication between the first and second ID-federation service providers.

8. The method of claim 1, wherein the providing of the corresponding Web service comprises:
transmitting a single logout request from the user to the Web service provider;
transmitting a logout request from the Web service provider to the second ID-federation service provider;
transmitting a logout request from the second ID-federation service provider to the first ID-federation service provider;
the first ID-federation service provider completing a user logout and transmitting a logout confirmation message to the second ID-federation service provider; and
the second ID-federation service provider performing a logout to transmit the corresponding information to the Web service provider, and the Web service provider completing a user logout to transmit a logout confirmation message to the user.

9. A method for providing a Single Sign-On (SSO) service enabling the use of Web services in different trusted domains through a one-time authentication process, the method comprising:
a user registering a real-name user ID in an ID-federation service provider;
the ID-federation service provider issuing an anonymous user ID corresponding to the real-name user ID;
setting one or more Web service providers in the trusted domain as a federated Web service provider at the request of the user; and
the user connecting to the federated Web service provider through the anonymous user ID at the request for connection to the federated Web service provider.

10. The method of claim 9, wherein the setting of the one or more Web service providers as the federated Web service provider comprises:
the ID-federation service provider receiving information of a Web service provider to be federated from the user;
transmitting an ID federation request to the Web service provider;
receiving an ID federation confirmation message from the Web service provider;
generating and transmitting federated authentication information to the Web service provider upon receipt of the ID federation confirmation message; and
the Web service provider receiving the federated authentication information and completing user authentication using the received federated authentication information.

11. The method of claim 9, further comprising:
the user transmitting an ID federation release request to the ID-federation service provider;
the ID-federation service provider relaying the ID federation release request to the Web service provider; and
the Web service provider releasing the ID federation and transmitting an ID federation release confirmation message to the ID-federation service provider and the user.

12. A system for providing a Single Sign-On (SSO) service enabling the use of Web services in first and second trusted domains through a one-time authentication process, the system comprising:
a first ID-federation service provider for managing a plurality of first Web service providers in the first trusted domain;
a second ID-federation service provider for managing a plurality of second Web service providers in the second trusted domain; and
a trusted third party for issuing authentication information for authentication of the first and second ID-federation service providers,
wherein when a service provision request is transmitted from a user terminal in the first trusted domain to the second Web service provider in the second trusted domain, the first and second ID-federation service providers perform mutual authentication by using the authentication information and perform a user authentication process by sharing federated authentication information generated by the first ID-federation service provider.

13. The system of claim 12, wherein the second ID-federation service provider receives an authentication request from the second Web service provider, confirms the first ID-federation service provider from the user, and transmits a user authentication request to the first ID-federation service provider.

14. The system of claim 13, wherein the first ID-federation service provider authenticates the user in response to the user authentication request, generates federated authentication information, and transmits the federated authentication information to the second ID-federation service provider.

15. The system of claim 14, wherein the second Web service provider receives the federated authentication information from the second ID-federation service provider, performing the user authentication by using the federated authentication information, and provides a corresponding Web service.

16. The system of claim 12, wherein the first and the second ID-federation service provider issues an anonymous user ID corresponding to a registered real-name ID of a user in the first/second trusted domain.

17. The system of claim 12, wherein the first and second ID-federation service providers share a session key generated through the mutual authentication, and encrypt or decrypt the federated authentication information with the session key.

18. The system of claim 12, wherein the first or second ID-federation service provider includes a multiple domain ID management table for managing the anonymous IDs of users in other trusted domains.

19. The system of claim 12, wherein the federated authentication information is generated using pre-registered authentication information.
